(19) United States
(12) Patent Application Publication
(10) Pub. No.: US 2015/0077261 A1
(43) Pub. Date: Mar. 19, 2015

(54) Diaper Change Detection Means

(71) Applicant: Dennis Lineberry, CastleRock, CO (US)

(72) Inventor: Dennis Lineberry, CastleRock, CO (US)

(21) Appl. No.: 14/027,202

(22) Filed: Sep. 15, 2013

(51) Int. Cl. G08B 21/20

(52) U.S. Cl. CPC G08B 21/20
USPC 340/604

(57) ABSTRACT

The diaper change detection means includes a hand held case, particulate sensor, speaker, light, processing means, and powering means. The sensor is held in the hand and held up to the diaper where said sensor can detect the presence of particulates emanating from the soiled diaper. The sensor would be held outside of clothing but near enough to the diaper to detect the particulates. The activation button would be depressed by the user. The processing means receives a signal from the sensor, and transmits an audible alarm in the form of a beep via the speaker. The alerting means also includes a light to show the state of the sensor.

### BACKGROUND OF THE INVENTION

1. Field of the Invention

The present invention relates to the field of diapers. More particularly, the present disclosure relates to diapers that have alerting means that emit an alarm upon detection of a dirty diaper.

2. Description of Related Art

As a preliminary note, it should be stated that there is an ample amount of prior art that deals with diapers. As will be discussed immediately below, no prior art discloses a diaper alerting means that includes a hand held particulates sensor and speaker or light to emit an audible and visual alarm to the presence of soiling of a diaper; wherein the alerting means is integrated into the design of hand held case.

The Gabriel Patent (U.S. Pat. No. 6,870,479) discloses a wetness monitoring system for an infant or adult diaper, which includes a sensor and a monitoring unit with auditory, light, or vibrational alarms. However, the monitoring system requires the use of a monitor with a display as opposed to an alarm system integrated into the system, which is hand held.

The Jeutter et al. Patent (U.S. Pat. No. 6,603,403) discloses a remote wetness signaling system for a diaper that includes a sensor and an alert signal that can be sent to a remotely located monitor. However, the signaling system is not a hand held particulate sensor, but rather includes a wireless receiver for receiving a signal indicating that the diaper has been soiled via wetness.

The Rasfeld Patent (U.S. Pat. No. Des. 342,569) illustrates an ornamental design for a wetness indicating diaper, which does not depict a speaker or sensor therein.

The Emenike et al. Patent (U.S. Pat. No. 7,145,053) discloses a baby diaper with a removable moisture indicator that sounds an audible alarm and visual LED lights alerting the diaper is soiled. However, the indicator is selectively attached onto an existing diaper as opposed to a hand held particulate sensor.

The Johnson Patent (U.S. Pat. No. 5,838,240) discloses a wet diaper detection device that visually and audibly alert parents when a diaper needs to be changed. However, the detector is positioned in a front portion of a diaper, and is attached thereon; whereas the present device is hand held and detects the presence of particulates.

The Fard Patent (U.S. Pat. No. 6,097,297) discloses a diaper that has a fastening device that is also a moisture sensor and signal transmitter to a remote receiver to alert a caregiver of a soiled diaper. Again, the device fastens along a side surface of the diaper and is detecting moisture, not a hand held particulate detection device.

The Mohammed et al. Patent (U.S. Pat. No. Des. 423,955) illustrates a design for a diaper wetness indicator, which does not depict a hand held particulate sensor.

The Mahgerefteh et al. Patent (U.S. Pat. No. 5,570,082) discloses a sensor for a diaper that sends an alert signal to a remote location when moisture is detected. However, the system utilizes a transmitter to communicate an alarm to a remote location. Also, this is not a particulate sensor.

The Mahoney Patent (U.S. Pat. No. 4,106,001) discloses a clip-on garment device with a detection strip that is used to alert when a diaper has become soiled. Again, the device fastens along a side surface of the diaper and is not hand held nor is it a particulate sensor.

The Yoo Patent (U.S. Pat. No. 4,484,573) discloses a diaper that utilizes a buzzer that when the moisture detector indicates moisture is present in the diaper, the detector signals a beeper. However, the detector is not hand held nor does it detect particulates.

The Novella Patent(U.S. Pat No. 8,314,284) discloses a diaper alerting means that includes an oblong sensor that detects wetness inside a diaper. The sensor alerts using a musical tone. However, this sensor does not detect particulates and is not hand held.

While the above-described devices fulfill their respective and particular objects and requirements, they do not describe a diaper alerting means that includes a hand held particulate sensor and speaker to emit an audible alarm and light bulb to emit light to the presence of soiling of a diaper. In this regard, the diaper change detecting means departs from the conventional concepts and designs of the prior art.

### SUMMARY OF THE INVENTION

The diaper change detecting means includes a hand held sensor, speaker, light bulb, processing means, and powering means. The sensor is encased in a hand held case that has a section that is permeable to particulates. This allows the sensor to detect particulates that are emitted from a soiled diaper. The alerting means and sensor are enclosed in the hand held case and when the user presses the button, the sensor begins to actively detect particulates that pass through the hand held case particulate permeable section. The processing means receives a signal from the particulate sensor, and transmits an alarm in the form of a noise via the speaker and light via the light bulb.

It is an object of the invention to provide a hand held diaper change detecting means that senses particulates and emits an alarm in the form of a noise and a light.

A further object of the invention is to provide a sensor that is hand held in shape so as to provide sensing capabilities about the main portion of the diaper that may be obscured by a thin layer of clothing.

A further object of the invention is to provide an alerting means that can detect diaper soiling without direct contact with said soiling but through the detection of soiling particulates.

A further object of the invention is to provide an alerting means that is powered by a powering means comprising at least one battery.

These together with additional objects, features and advantages of the diaper change detecting means will be readily apparent to those of ordinary skill in the art upon reading the following detailed description of presently preferred, but nonetheless illustrative, embodiments of the diaper change detecting means when taken in conjunction with the accompanying drawings.

In this respect, before explaining the current embodiments of the diaper change detecting means in detail, it is to be understood that the diaper change detecting means is not limited in its applications to the details of construction and arrangements of the components set forth in the following description or illustration. Those skilled in the art will appreciate that the concept of this disclosure may be readily utilized as a basis for the design of other structures, methods, and systems for carrying out the several purposes of the diaper change detecting means.

It is therefore important that the claims be regarded as including such equivalent construction insofar as they do not depart from the spirit and scope of the diaper change detecting means. It is also to be understood that the phraseology and terminology employed herein are for purposes of description and should not be regarded as limiting.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention:

In the drawings:

FIG. 1 illustrates a front, isometric view of the hand held diaper change detecting means, and depicting the visual indicator and activation button;

FIG. 2 illustrates a back, isometric view of the hand held diaper change alerting means, and details the permeable section in the case that allows for particulates to pass to the sensor;

FIG. 3 illustrates an internal diagram of the various components of the hand held diaper change detecting means;

### DETAILED DESCRIPTION OF THE EMBODIMENT

The following detailed description is merely exemplary in nature and is not intended to limit the described embodiments of the application and uses of the described embodiments. As used herein, the word “exemplary” or “illustrative” means “serving as an example, instance, or illustration.” Any implementation described herein as “exemplary” or “illustrative” is not necessarily to be construed as preferred or advantageous over other implementations. All of the implementations described below are exemplary implementations provided to enable persons skilled in the art to practice the disclosure and are not intended to limit the scope of the appended claims. Furthermore, there is no intention to be bound by any expressed or implied theory presented in the preceding technical field, background, brief summary or the following

### DETAILED DESCRIPTION

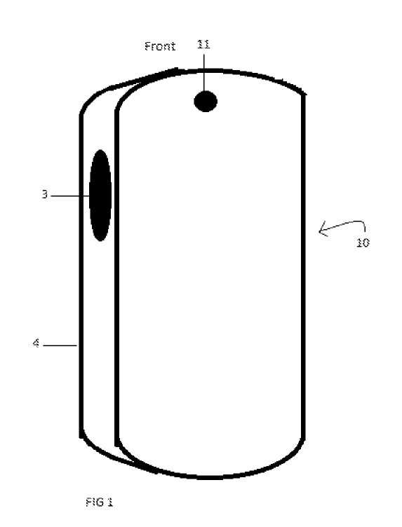

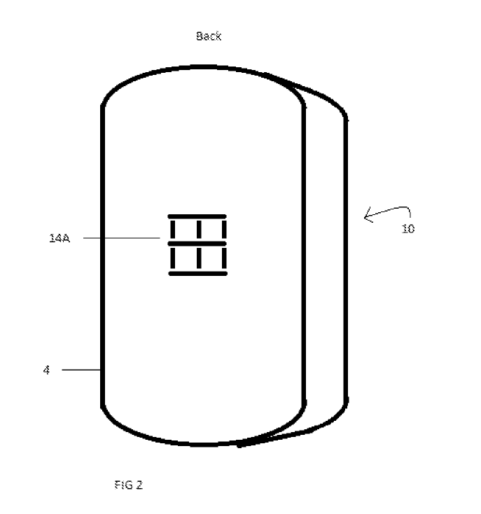

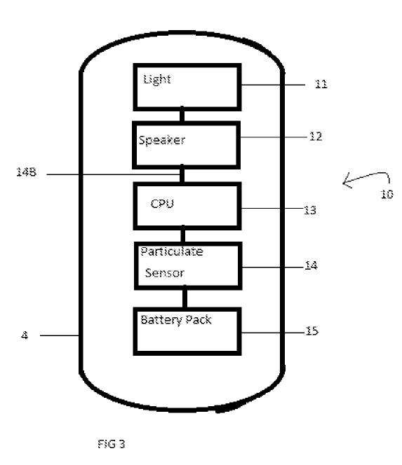

Detailed reference will now be made to the present invention, examples of which are illustrated in FIGS. 1-3. A hand held diaper change detecting means 10 (hereinafter hand held sensor) includes an a hand held case 4, a particulate sensor 14, a processing means 13, a speaker 12, a light 11, and activation button 3, and a powering means 15.

The hand held case 4 shall include an area to be of permeable construction 14A so as to allow particulates to penetrate in order to be sensed by the particulate sensor 14.

The particulate sensor 14 senses particulates in order to detect soiling. The particulate sensor 14 is positioned within the hand held case 4. It shall be noted that particulate sensor 14 is completely encased in the hand held case 4 and does not need direct contact with the soiling or moisture in the diaper to detect said soiling. But instead particulates pass through the permeable section 14A of the hand held case 4. This will protect an actual end user from transmission of harmful bacteria or other harmful biological agents, which are associated with soiling materials.

The processing means 13 may also be referred to as a central processing unit (hereinafter CPU). The processing means 13 receives a signal from the particulate sensor 14 via wiring 14B. The processing means 13 in turn emits a noise via the speaker 12 and a light via the light bulb 11.

The electrical needs of the particulate sensor 14 are provided by the battery pack 15. The battery pack 15 comprises of at least one battery. The battery pack 15 is responsible for supplying electrical energy to the particulate sensor 14, the processing means 13, the speaker 12, and the light 11. The particulate sensor 14 begins detecting particulates when the activation button 3 is pressed.

With respect to the above description, it is to be realized that the optimum dimensional relationship for the various components of the invention 10, to include variations in size, materials, shape, form, function, and the manner of operation, assembly and use, are deemed readily apparent and obvious to one skilled in the art, and all equivalent relationships to those illustrated in the drawings and described in the specification are intended to be encompassed by the invention 10.

It shall be noted that those skilled in the art will readily recognize numerous adaptations and modifications which can be made to the various embodiments of the present invention which will result in an improved invention, yet all of which will fall within the spirit and scope of the present invention as defined in the following claims. Accordingly, the invention is to be limited only by the scope of the following claims and their equivalents.

The inventor claims:

1. A diaper change detection means comprising:
a) a sensor housing that is hand held;
b) a particulate sensor capable of detecting soiling agents contained within said housing;
c) a processing means that receives a signal from said particulate sensor;
d) at least one alarm;
e) a powering means;
f) and an activation button.

2. The diaper change detection means as described in claim 1 wherein the powering means consists of at least one battery.

3. The diaper change detection means as described in claim 1 wherein the alarm comprises an audible noise.

4. The diaper change detection means as described in claim 1 wherein the alarm comprises a light emission.

5. The diaper change detection means as described in claim 1 wherein sensor, processing means, and the powering means are integrated into the hand held sensor.

6. The diaper change detection means as described in claim 1 wherein the sensor is encased in a hand held case with a particulate permeable section.

7. The diaper change detection means as described in claim 1 wherein the sensor is activated using an activation button.
